(19) United States
(12) Patent Application Publication
(10) Pub. No.: US 2005/0007726 A1
(43) Pub. Date: Jan. 13, 2005

(54) Ion-driven air pump device and method

(76) Inventors: Daniel J. Schlitz, Lilburn, GA (US); Suresh V. Garimella, West Lafayette, IN (US); Timothy S. Fisher, West Lafayette, IN (US)

Correspondence Address: Mr. Edward J. Timmer, P.O. Box 770, Richland, MI, 49083-0770, US

(21) Appl. No.: 10/754,441

(22) Filed: Jan. 9, 2004

Related U.S. Application Data
(60) Provisional application No. 60/439,568, filed on Jan. 10, 2003.

(51) Int. Cl. H01G 4/38

(52) U.S. Cl. 361/330

(57) ABSTRACT

A gaseous fluid microscale pump device and method for creating a flow of gaseous heat transfer fluid, such as air, wherein the pump device includes an ion generating region including one or more electron-emitting cathode electrodes for generating unipolar ions in the fluid, and a pumping region disposed downstream of the ion generating region and including pumping electrodes for generating an electric field in a manner that imparts motion to the ions and thus the heat transfer fluid relative to a heat-generating electronic component.

This application claims the benefits and priority of provisional application Ser. No. 60/439,568 filed Jan. 10, 2003.

### CONTRACTUAL ORIGIN OF THE INVENTION

This invention was supported by funding from the Federal Government through the National Science Foundation under Contract/Grant No. 0222553-CTS. The Government may have certain rights in the invention.

### FIELD OF THE INVENTION

The present invention relates to an ion driven, fluid flow-generating microscale pump device and method for creating a flow of a gaseous fluid (e.g. air) for the purpose of cooling solid objects.

### BACKGROUND OF THE INVENTION

Rapidly decreasing feature sizes and increasing power density in microelectronic devices has necessitated development of cooling strategies to achieve very high heat removal rates from these devices. For example, heat removal rates in excess of 40 W/cm² have been projected for the next generation of personal computing devices. Microchannel heat sinks have the potential to achieve these heat removal rates and therefore have been studied for over two decades as described, for example, by Tuckerman and Pease in “High performance heat sinking for VLSI”, IEEE Electron Device Letters, Vol. EDL-2, pp. 126-129, 1981, and by Garimella and Sobhan in “Transport in microchannels-A critical review”, Annual Review of Heat Transfer, Vol. 14, 2003. However, the high pressure drops encountered in microchannels have largely precluded their use in practical applications thus far. In particular, such microchannel heat sinks require an external pump to drive the fluid through the microchannels. The need for an external pump is disadvantageous in that relatively large amounts of electrical power and space would be needed for the pump.

### SUMMARY OF THE INVENTION

An embodiment of the invention provides a microscale pump device and method for creating a flow of a gaseous fluid wherein the pump device includes an ion generating region including one or more electron-emitting cathode electrodes for generating unipolar ions in the gaseous fluid and further includes a pumping region disposed downstream of the ion generating region and including pumping electrodes for generating an electric field in a manner that imparts motion to the unipolar ions and thus the fluid in a selected direction.

In an illustrative embodiment of the invention, the ion generating region comprises one or more low-voltage, electron-emitting cold cathode electrodes. The one or more electron-emitting cathode electrodes each emits a beam or stream of electrons that collide with neutral fluid molecules (e.g. air molecules) to generate unipolar ions at ambient temperature and at relatively low electrode voltage. The pumping region is disposed downstream (relative to fluid flow) of the ion generating region and comprises a series of pumping electrodes whose polarity is switched in a manner to generate a translating electric field that imparts motion to the unipolar ions and thus the fluid in a direction for removing heat from a heat-generating electronic component. Preferably, the pumping electrodes reside on one or more heat transfer surfaces (e.g. on a surface of one or more microchannels and/or on pin cooling fins). The invention converts electrical energy directly into motion of a heat transfer fluid.

A particular method embodiment of the invention involves removing heat from a heat-generating electronic component comprising the steps of emitting electrons from an electron-emitting cathode electrode to generate unipolar ions in a gaseous heat transfer fluid and establishing an electric field to impart motion to the ions and thus the heat transfer fluid relative to the heat-generating component.

Another embodiment of the invention provides an ion generator useful for generating unipolar ions in ambient air.

Still another embodiment of the invention provides a gaseous fluid pump comprising a series of pumping electrodes disposed along a fluid flow path for generating an electric field in a manner that imparts motion to unipolar ions present in the gaseous fluid and thus to the fluid in the direction of the flow path.

Features and advantages of the present invention will become more apparent from the following detailed description taken in conjunction with the following drawings.

### DESCRIPTION OF THE DRAWINGS

FIG. 1 is a schematic perspective view of a microscale pump device pursuant to an embodiment of the invention having an ion generating region and a pumping region with microchannel heat sinks residing in thermal transfer relation on a heat-generating microelectronic chip.

FIG. 2 is a schematic view of an ion generating region of a pump device pursuant to another illustrative embodiment of the invention.

FIG. 3a is a schematic view showing a pair of pumping electrodes located in a microchannel of a pumping region of a fluid pump device pursuant to an illustrative embodiment of the invention.

FIG. 3b is a schematic view of a plurality of sets of pumping electrodes arranged in series along a microchannel of a heat sink of the pumping region pursuant to an illustrative embodiment of the invention.

### DESCRIPTION OF THE INVENTION

The present invention provides a microscale ion driven air flow pump device 10 and method useful for, although not limited to, removing heat from a heat-generating electronic component, such as for purposes of illustration and not limitation, an IC chip (integrated circuit chip) of an electronic device such as cell phones, laptop computers, personal digital assistance devices, desktop computers, and the like. Although the microscale pump device is illustrated and described in connection with a microchannel cooling scheme, the invention is not so limited and can be used in connection with other cooling schemes such as cooling fins and other heat transfer surfaces that may be provided in thermal transfer relation with a heat-generating electronic component.

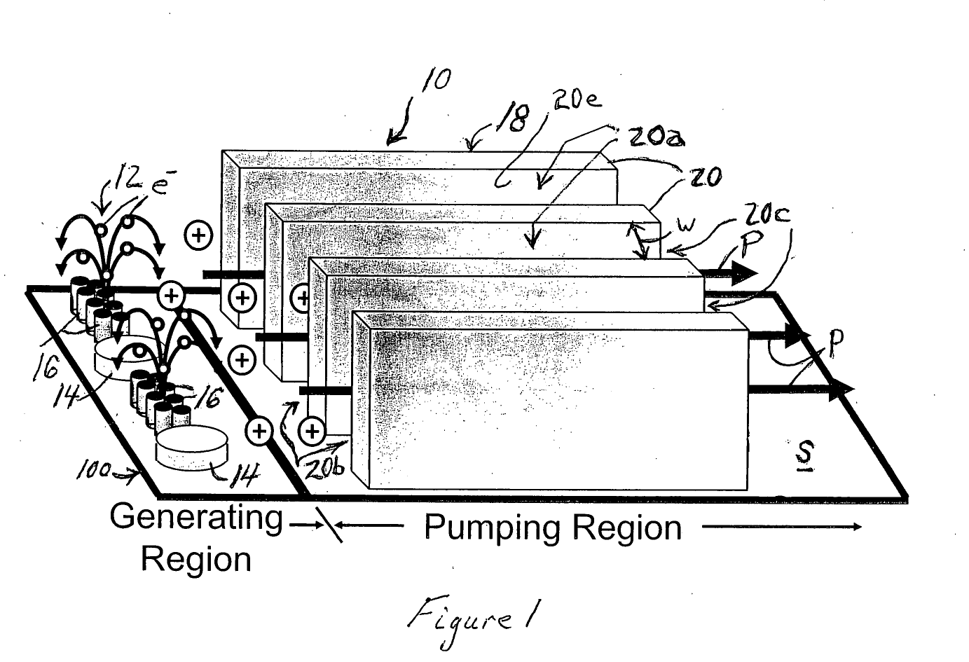

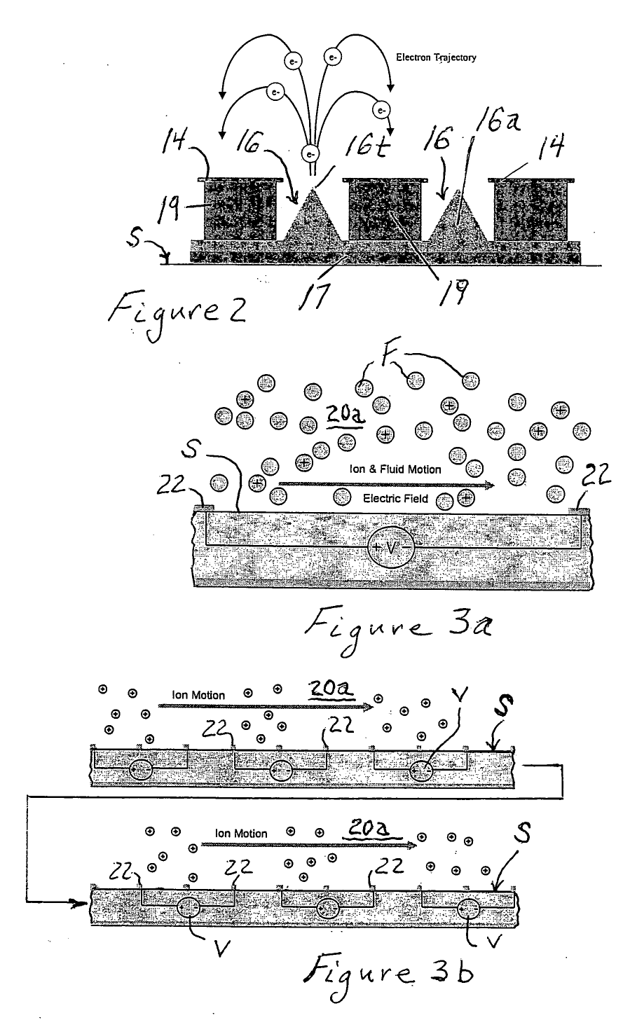

Referring to FIG. 1, the microscale pump device 10 is shown cooperatively associated with a heat-generating microelectronic chip 100 shown schematically. In particular, the pump device 10 is shown disposed on a surface S of the heat-generating chip 100. The pump device 10 comprises an ion generating region 12 including one or more anode electrodes 14 and one or more electron-emitting cathode electrodes 16 for generating unipolar ions designated by the + sign in FIG. 1 in a gaseous fluid, such as ambient or atmospheric air present about the pump device, when a voltage is applied between the anode(s) and the cathode electrode(s). Once created, the unipolar ions move into the pumping region 18 of the pump device 10 as illustrated in FIG. 1. The pumping region 18 is disposed downstream of the ion generating region 12 relative to direction of flow of the gaseous fluid and includes a plurality of microchannel heat sinks 20. The pumping region 18 includes multiple pairs of pumping electrodes 22, FIG. 3b, for generating an electric field in a manner that imparts motion to the ions and thus the fluid in a selected direction along the microchannels 20a defined by the heat sinks 20. The pumping electrodes 22 are not shown in FIG. 1 for convenience and instead are shown in FIG. 3b. One or both of the ion generating region 12 and pumping region 18 may be formed integrally on surface S of the heat-generating chip 100, or one or both of the ion generating region 12 and pumping region 18 may be formed separate from the chip 100 and joined to the surface S of chip 100 in a manner that provides heat transfer from the chip 100 to the pump device 10. The ion generating region 12 and the pumping region 18 are shown exaggerated in size relative to chip 100 in FIG. 1 for purposes of illustrating the invention.

In FIG. 1, the ion generating region 12 is shown for purposes of illustration and not limitation comprising a plurality of anode electrodes 14 and a plurality of electron-emitting cathode electrodes 16 is a row and column array between the anode electrodes. However, the anode and cathode electrodes 14, 16 can be disposed in any arrangement that functions to emit electrons from the cathode electrodes into a gaseous fluid (e.g. atmospheric air) present at the ion generating region 12 to generate unipolar ions in the fluid (e.g. air) at the ion generating region.

The unipolar ions are created in the ion generating region 12 through a process of electron emission from the cathode electrodes 16 followed by a series of ionizing collisions with ambient air molecules when the gaseous fluid comprises ambient air. The electron-emitting cathode electrodes can comprise arrays of multiple cathode emitters 16a disposed on a cathode substrate 17 as illustrated schematically in FIG. 2. The cathode emitters 16a and associated anodes 14 can be arranged in a row and column array or grid or any other array to this end. The features of the ion generating region 12 can be provided on surface S by physical or chemical vapor film deposition and etching techniques or by other nanofabrication techniques or can be formed separately and joined to the surface S depending upon the chip structure and materials employed. The anodes 14 each can comprise insulated gates electrically insulated from the cathode electrodes by gate insulator 19. The cathode emitters 16a can comprise polycrystalline diamond or a polycrystalline diamond film for purposes of illustration and not limitation, although other materials can be used for the electron-emitting cathode electrodes. The cathode electrodes 16 can possess sharp, nanoscale features to enhance the local electric field at the solid electrode boundary. For example, each cathode electrode 16 of FIG. 2 includes a sharp, nanoscale conical tip 16t to this end. Similarly, the grain boundaries of polycrystalline film material that may used as the cathode electrode can serve to enhance the local field, thereby allowing for sizeable emission currents at low voltages. These types of electron-emitting cathodes do not require heating and thus are termed cold cathode electrodes. Use of the low voltage, electron-emitting cathode electrodes 16 in atmospheric air to create unipolar ions in the ion generating region 12 is advantageous to allow for the creation of unipolar ions in air (or other gaseous fluid) at room temperature and at relatively low voltages. The ions generated in the air are predominantly or entirely comprised of unipolar ions (single polarity ions) and contain few or no free electrons so as to provide a high electromechanical conversion efficiency, which will create high air flow rates.

The electric field enhancement of cold-cathode electrodes 16 concentrates the applied electric field such that the process of electron emission occurs at a relatively low voltage such as, for example, from about 5 to about 400 V for purposes of illustration and not limitation since other voltages may be used in practice of the invention. FIG. 2 illustrates schematically the emission of electrons designated e from the apex of tip 16t of cold cathode emitter electrode 16 upon the application of positive voltage or bias on the anode electrodes 14 using a conventional voltage source (not shown) connected between the anode electrodes and the cathode electrodes. The electron emission is highly directional and creates a beam of electrons that shoots directly outward and then curls back toward the gate electrodes 14. This electron emission action takes advantage of the strong directionality of field emission. Due to local geometry, the local electric field enhancement will be maximum at the apex of the tip 16t. Consequently, emitted electrons possess very strong directional orientation perpendicular to the base plane. This directionality promotes longer, fountain-like trajectories of the electron beams as illustrated in FIG. 2 that substantially increase the probability of gas ionization in the atmospheric or ambient air (or other gaseous fluid) at higher elevations of the trajectories.

Unipolar positive ions are created by collisions between the electrons and the neutral charge air molecules when ambient air comprises the fluid. At sufficiently high electric field strengths, these collisions result in the liberation of an electron from the neutral air molecule. The reaction creates a positive ion and an additional free electron. The free electrons eventually reach the anodes 14 and are removed from the system.

Unipolar negative ions can be created in a similar manner to the unipolar positive ions described, but at lower field strengths. For example, free electrons, in the presence of a lower electric field, can collide and attach themselves to oxygen molecules in the air and create a stable unipolar negative ion.

The electron-emitting cathode electrodes 16 also can comprise arrays of multiple carbon nanotube emitter electrodes as illustrated, for example, schematically in FIG. 1 for purposes of illustration and not limitation, or any other suitable electron-emitting cathode structure. The electron-emitting cathode electrodes 16 can be used as cathodes in diode and triode devices with integrated anode and/or grid structures.

The pumping region 18 is disposed downstream (relative to fluid flow) of the ion generating region 12 and comprises multiple pairs of pumping electrodes 22 which are arranged in series along fluid flow paths P defined by individual microchannel heat sinks 20, FIG. 1, and whose polarity is switched in a manner to generate a translating electric field that imparts motion to the unipolar ions and thus the fluid in the direction of the fluid flow paths P for removing heat from a heat-generating chip 100. The pairs of pumping electrodes 22 are connected to a voltage source V by the electrical leads as schematically shown in FIG. 3b and which are used to create a strong electric field through which the unipolar ions, supplied from the ion generating region 12, move. It is advantageous to scale down the spacing of the pumping electrodes 22 such that high electric fields are created with relatively low voltages (e.g. less than 100V). In the pumping region 18, the unipolar ions are accelerated by the electric field generated by the pairs of pumping electrodes 22 so as to collide repeatedly with neutral charge molecules (e.g. air molecules) and thereby transfer momentum to the bulk fluid F. FIG. 3a illustrates schematically subjecting the unipolar ions in a neutral gaseous fluid (e.g. air) to an electric field generated by pumping electrodes 22 to create a body force in the neutral fluid (e.g. air) F that establishes ion and bulk fluid motion in the direction of the arrow. The pumping region thereby converts electrical power directly to fluid motion.

The microchannel heat sinks 20 can be formed integrally on the surface S of the chip 100 using silicon micromachining processes or other suitable fabrication processes, or the heat sinks 20 can be formed as a separate body that is joined to the chip surface S in a manner that provides heat transfer from the chip 100 to the heat sink body. For purposes of illustration and not limitation, the microchannels 20a defined between the heat sinks 20 each can have a cross-sectional area of 50,000 microns² or less, such as a vertical channel depth normal to chip surface S in FIG. 1 of about 500 microns, a channel width w of about 100 microns and appropriate length extending between a channel inlet 20b adjacent the ion generating region 12 and channel outlet 20c remote therefrom. The number of microchannels and heat sinks employed in practice of the invention can be selected to achieve desired heat removal from the chip 100. Although the microchannels 20a are shown as having a rectangular cross-sectional shape, they can have any other suitable cross-sectional shape.

Pumping of the gaseous fluid (e.g. air) through the microchannels 20a between the heat sinks 20 is achieved by employing a series of pairs of electrically insulated pumping electrodes 22 as depicted in FIG. 3b. The unipolar ions are constrained by the electrodes 22 to move in packets through the microchannels 20a between the heat sinks 20. Meso-scale motion is obtained by changing the polarity of the pumping electrodes 22 rapidly over time in such a manner as to create a continuous force on the ions. The electrode voltage is switched from positive to negative polarity in such a way that the electric field always applies a downstream force on the unipolar ions. Switching frequencies on the order of 1 MHz can be used for purposes of illustration and not limitation since other switching frequencies may be used in practice of the invention.

The electric field established by the pumping electrodes 22 will not be high enough to ionize air. Insulation (not shown) over the pumping electrodes 22 will prevent free electrons from being emitted from these surfaces. Thus, the only charges moving through the pumping region are the unipolar ions created in the ion generating region 12. These ions, by collisions with neutral molecules, will efficiently convert electric power into fluid motion. In particular, the ionized air molecules (unipolar ions) are accelerated by the electric field imposed by the pumping electrodes 22. The ions collide with neutral air molecules according to the mean free path length, which is approximately 60 nm for air at room temperature and pressure. It can be assumed that the ions lose all of their momentum to the neutral molecule after each collision. The transfer of momentum from the ions to the bulk fluid, therefore acts as a body force b given by: b=(Ep)/(density of fluid), where E is the electric field and p is the charge density. In a set of calculations, it was found that a body force of b=150,000 m/s² is to be expected from pumping electrodes spaced apart by 100 microns at 100 volts. This compares to a body force for natural convection of only approximately 1 m/s². Calculations predict that with a body force of only b=100,000 m/s², air velocities approaching 80 m/s and average convection coefficients exceeding 150 W/m² K can be achieved for flow over a flat surface in 40 mm length. With surface enhancement, the effective convection coefficient can be significantly increased.

The microscale proportions of the pumping electrodes 22 allow them to be integrated on a heat transfer surface of the microchannel heat sinks 20, keeping the air flow in intimate contact with the microscale heat sinks and thus dissipating large heat fluxes without the use of ducting. The invention produces microscale air flow integrated within micro-featured heat sinks 20. The micro-scale pump device 10 works without moving parts for use in a variety of small-scale electronics packaging applications. High performance heat removal technologies such as microchannels, which hitherto limited in their implementation because of large pumps required, can be viable since the flow is crated by a “pump” that is itself truly at the microscale. Much higher power densities can be dissipated right at the chip level without the need to resort to bulky pumping technologies.

For purposes of illustration and not limitation, the pumping electrodes 22 are shown in FIG. 3b residing on the chip surface S that forms the bottom wall of the microchannels 20a although the invention is not limited to a particular location of the pumping electrodes 22 since they can be located on one or more heat transfer surfaces of the heat sinks 20 and/or chip 100 in a manner to move the unipolar ions along with the bulk fluid from the inlets 20b to the outlets 20c of the microchannels 20a.. For example, the pumping electrodes 22 may be provided on vertical side surfaces 20e of each heat sink 20 to this end. The pumping electrodes 22 can be provided on one or more of the heat transfer surfaces of the heat sinks 20 and/or the chip 100 by physical or chemical vapor film deposition or other nanofabrication techniques.

As mentioned above, it is advantageous to scale down the spacing of the pumping electrodes 22 such that high electric fields are created with relatively low voltages (e.g. less than 100V ). With electrode spacing on the order of micrometers, air flow is established and controlled easily at microscale dimensions such that high electric fields and high flow rates can be created at low voltages by pumping electrodes 22 without creating unwanted additional ions or free electrons. The pumping electrode spacing, applied voltage, switching frequency, and on-current can be selected to provide a desired maximum fluid flow velocity, heat transfer rate, and electro-mechanical conversion efficiency for a given heat removal application.

Ion driven air flow pursuant to the invention is a novel method of pumping air or other gaseous fluid at microscale dimensions using ion drag. The method employs the series of micro-fabricated pumping electrodes 22 to generate strong electric fields that pump unipolar ions through air or other gaseous fluid. The ions collide repeatedly with neutral molecules thus generating bulk fluid motion. Meso-scale motion is obtained by changing the polarity of the pumping electrodes rapidly over time in such a manner as to create a continuous force on the ions. The invention can be used to generate airflow through microchannel heat sinks 20, or other micro-featured heat transfer surfaces to create compact, high flux heat sinks for electronic cooling.

Although the invention has been described with respect to certain embodiments thereof, those skilled in the art will that changes and modifications can be made thereto within the scope of the invention as set forth in the appended claims.

1. A pump device for gaseous fluid, comprising an ion generating region having an electron-emitting cathode electrode for generating unipolar ions in the fluid and a pumping region disposed downstream of the ion generating region, said pumping region including pumping electrodes for generating an electric field in a manner that imparts motion to the ions and thus to the fluid.

2. The pump device of claim 1 wherein the electron-emitting cathode electrode emits electrons at room temperature in atmospheric air.

3. The pump device of claim 1 including an anode to which a positive voltage bias is applied to cause the cathode electrode to emit electrons into the fluid.

4. The pump device of claim 1 wherein the electron-emitting cathode electrode includes a conical tip.

5. The pump device of claim 1 wherein the pumping region comprises a series of pumping electrode sets whose polarity is switched in a manner to generate an electric field that imparts motion to the unipolar ions and thus the fluid in the direction.

6. Combination of a heat generating electronic component and a cooling system in thermal transfer relation with the heat-generating component to remove heat therefrom using a gaseous heat transfer fluid, said cooling system including a plurality of pump devices of claim 1 to impart motion to the heat transfer fluid relative to the heat-generating component.

7. The combination of claim 6 wherein the pumping electrodes reside on one or more heat transfer surfaces.

8. The combination of claim 7 wherein the one or more heat transfer surfaces comprise one or more surfaces of the component or a heat sink in heat transfer relation with the component.

9. A method of generating a flow of a gaseous fluid, comprising emitting electrons from an electron-emitting cathode electrode into a gaseous fluid to generate unipolar ions in the fluid and establishing an electric field that imparts motion to the ions and thus the fluid.

10. A method of removing heat from a heat-generating electronic component, comprising emitting electrons from an electron-emitting cathode electrode into a gaseous heat transfer fluid to generate unipolar ions in the heat transfer fluid and establishing an electric field that imparts motion to the ions and thus the heat transfer fluid relative to the component to remove heat therefrom.

11. The method of claim 10 wherein the electrons are emitted at room temperature in atmospheric air.

12. The method of claim 11 wherein the electrons are emitted from a conical tip of the electron-emitting cathode electrode.

13. The method of claim 10 wherein the electrons are emitted as a fountain-like electron stream.

14. The method of claim 10 wherein the heat transfer fluid is air.

15. The method of claim 10 wherein a translating electric field is generated downstream of the cathode electrode by switching polarity of a series of pumping electrode pairs to impart motion to the ions and thus the heat transfer fluid relative to the component.

16. The method of claim 10 including disposing the pumping electrodes on a heat transfer surface of the component or of a heat sink in thermal transfer relation with the component.

17. An ion generator, comprising an anode electrode and a cathode electrode for emitting electrons into a gaseous fluid in a manner to generate unipolar ions in the gaseous fluid when a voltage is applied between the anode electrode and the cathode electrode.

18. The ion generator of claim 17 wherein the anode electrode and the cathode electrode are disposed in air to generate unipolar ions therein.

19. A gaseous fluid pump, comprising a series of pumping electrodes disposed along a fluid flow path for generating an electric field in a manner that imparts motion to unipolar ions present in the gaseous fluid and thus to the fluid in the direction of the flow path.

20. The pump of claim 19 wherein the electric field imparts motion to unipolar ions present in air.
